(19) United States
(12) Patent Application Publication
(10) Pub. No.: US 2025/0367555 A1
(43) Pub. Date: Dec. 4, 2025

(54) INTERACTION CONTROL METHOD AND APPARATUS FOR VIRTUAL PROP, AND ELECTRONIC DEVICE

(71) Applicant: NETEASE (HANGZHOU) NETWORK CO., LTD., Hangzhou (CN)

(72) Inventors: Ruijia ZHANG, Hangzhou (CN); Yong MAO, Hangzhou (CN); Yuanyuan ZHU, Hangzhou (CN)

(21) Appl. No.: 18/875,469

(22) PCT Filed: Oct. 26, 2022
(86) PCT No.: PCT/CN2022/127750

§ 371 Date: Dec. 16, 2024

(30) Foreign Application Priority Data
Jun. 17, 2022 (CN) 202210692480.7

(51) Int. Cl. A63F 13/55; A63F 13/355; A63F 13/533; A63F 13/837

(52) U.S. Cl. CPC A63F 13/55; A63F 13/533; A63F 13/837; A63F 13/355

(57) ABSTRACT

The present disclosure provides an interaction control method for a virtual prop. The method includes: displaying a prop operation interface by a graphical user interface, the prop operation interface including a target virtual prop carried by a controlled virtual object, and a sub-prop configuration display region for a sub-prop corresponding to the target virtual prop, where the sub-prop is configured as a prop discharged by the target virtual prop in a virtual scene, and the sub-prop configuration display region is configured for displaying a loaded sub-prop of the target virtual prop; determining, in response to a loading operation, a target sub-prop corresponding to the loading operation, and controlling the target sub-prop to be loaded to the target virtual prop; and updating display information in the sub-prop configuration display region, where the updated display information includes information corresponding to the target sub-prop.

### CROSS REFERENCE TO RELATED APPLICATIONS

The present disclosure is a 371 national phase application of PCT Application No. PCT/CN2022/127750 filed Oct. 26, 2022, which claims priority of the Chinese Patent Application No. 202210692480.7 filed on Jun. 17, 2022 and entitled “INTERACTION CONTROL METHOD AND APPARATUS FOR VIRTUAL PROP, AND ELECTRONIC DEVICE,” the entire content of both of which applications are hereby incorporated by reference for all purposes.

### TECHNICAL FIELD

The present disclosure relates to the technical field of interface interaction, and in particular, to an interaction control method and apparatus for a virtual prop, and an electronic device.

### BACKGROUND

Most shooting games involve a process of loading a firearm. In the related art, the bullet loading process is usually simulated through a relatively complicated process, such as first opening a container containing bullets, loading the bullets into a magazine, and then loading the magazine into the firearm. This process is relatively cumbersome and affects the user experience. In some other games, there is no process of loading bullets into firearms. Instead, but directly using bullets placed in backpacks of players. In this way, the players are deprived of the realistic experience of using firearms and the experience is poor.

### SUMMARY

According to a first aspect, the present disclosure provides an interaction control method for a virtual prop. The method includes: displaying a prop operation interface by a graphical user interface, the prop operation interface including a target virtual prop carried by a controlled virtual object, and a sub-prop configuration display region for a sub-prop corresponding to the target virtual prop, where the sub-prop is configured as a prop discharged by the target virtual prop in a virtual scene, and the sub-prop configuration display region is configured for displaying a loaded sub-prop of the target virtual prop, and the graphical user interface is provided by a terminal device; determining, in response to a loading operation, a target sub-prop corresponding to the loading operation, and controlling the target sub-prop to be loaded to the target virtual prop; and updating display information in the sub-prop configuration display region, where the updated display information includes information corresponding to the target sub-prop.

According to a second aspect, the present disclosure provides a system, including one or more memories collectively containing one or more programs, and one or more processors, where the one or more processors are configured to, individually or collectively, perform the operations in the above interaction control method for a virtual prop.

According to a third aspect, the present disclosure provides one or more non-transitory computer-readable storage media containing, in any combination, computer program code that, when executed by a computer system, performs the operations in the above interaction control method for a virtual prop.

### BRIEF DESCRIPTION OF THE DRAWINGS

FIG. 1 is a flowchart of an interaction control method for a virtual prop according to an embodiment of the present disclosure;

FIG. 2 is a schematic diagram of a prop operation interface displaying a sub-prop configuration display region according to an embodiment of the present disclosure;

FIG. 3 is a schematic diagram of a prop operation interface displaying sub-prop specific information according to an embodiment of the present disclosure;

FIG. 4 is a schematic diagram of a prop operation interface displaying a loading control according to an embodiment of the present disclosure;

FIG. 5 is a schematic diagram of a prop operation interface displaying a sub-prop storage display region according to an embodiment of the present disclosure;

FIG. 6 is a schematic diagram of a backpack weapon field according to an embodiment of the present disclosure;

FIG. 7 is a schematic diagram of a backpack weapon field displaying a loading icon according to an embodiment of the present disclosure;

FIG. 8 is a schematic diagram of a backpack weapon field with a bullet container in an interactive state according to an embodiment of the present disclosure;

FIG. 9 is a schematic diagram of a backpack weapon field with a bullet container in an interactive response state according to an embodiment of the present disclosure;

FIG. 10 is a flowchart of a process of automatic bullet loading by a system according to an embodiment of the present disclosure;

FIG. 11 is a flowchart of a process of selecting and loading bullets by a player according to an embodiment of the present disclosure;

FIG. 12 is a schematic structural diagram of an interaction control apparatus for a virtual prop according to an embodiment of the present disclosure; and

FIG. 13 is a schematic structural diagram of an electronic device according to an embodiment of the present disclosure.

### DETAILED DESCRIPTION

In order to make objectives, technical solutions, and advantages of the embodiments of the present disclosure clearer, the technical solutions in the present disclosure will be described clearly and completely through the accompanying drawings. Apparently, the described embodiments are a part of embodiments of the present disclosure, and are not all the embodiments. Based on the embodiments of the present disclosure, all other embodiments derived by those skilled in the art without any creative effort shall all fall within the protection scope of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

For the above interaction control method and apparatus for a virtual prop and the electronic device, a prop operation interface is displayed by a graphical user interface, the prop operation interface including a target virtual prop carried by a controlled virtual object, and a sub-prop configuration display region corresponding to the target virtual prop, where the sub-prop is configured as a prop which is fired in a virtual scene by the target virtual prop, and the sub-prop configuration display region is used for displaying a loaded sub-prop of the target virtual prop. A target sub-prop corresponding to a loading operation is determined in response to the loading operation, and the target sub-prop is controlled to be loaded to the target virtual prop. Display of display information in the sub-prop configuration display region is updated, where the updated display information includes information corresponding to the target sub-prop. The disclosed embodiments improve the player's user experience with the target virtual prop by simplifying the sub-prop loading process, thereby improving the overall usability.

Other features and advantages of the present disclosure will be set forth in the description which follows, and in part will be apparent from the specification, or may be learned by implementing the present disclosure. The objectives and other advantages of the present disclosure are realized and obtained by the structures particularly pointed out in the specification, claims, and drawings.

In order to make the above objectives, features, and advantages of the present disclosure more obvious and easy to understand, preferred embodiments are given below and described in detail with reference to the accompanying drawings

Most shooting games involve a function of loading (also referred to as “filling”) a firearm. Some realistic games use this function to simulate the real firearm experience, such as adding a manual loading (also known as “bullet loading”) step, through which different types of bullets with different damage capabilities can be included. In one of the methods, when a user uses the bullet loading function, the following process is adopted: the player needs to open the backpack, manually drag bullets into a magazine, and then drag the magazine into a firearm. In this method, it is required that the firearm is equipped with the magazine for loading bullets, and the loading steps are cumbersome and the loading time is long.

In order to simplify the process of using guns, some games have the following game logic: bullets can be used as long as they are placed in a player's backpack. However, this method fails to provide a realistic experience, and usually a gun can only be loaded with one type of bullets, resulting in a poor gaming experience for users.

Based on this, the embodiments of the present disclosure provide an interaction control method and apparatus for a virtual prop, and electronic device. This technology can be applied to various game scenarios that involve use of weapons.

The interaction control method for a virtual prop in one embodiment of the present disclosure may be run on a local terminal device or a server. When the interaction control method for a virtual prop runs on a server, the method may be implemented and executed based on a cloud interaction system, where the cloud interaction system includes a server and a client device.

In some embodiments, various cloud applications, such as cloud gaming, may be run under the cloud interaction system. Take the cloud gaming as an example, the cloud gaming refers to a gaming method based on cloud computing. In the cloud gaming running mode, a game program running entity and a game picture presentation entity are separated. The storage and operation of the interaction control method for a virtual prop are completed on a cloud gaming server. The client device is used for receiving and sending data and presenting a game picture. For example, the client device may be a display device with data transmission function close to the user side, such as a mobile terminal, a TV, a computer, and a PDA. However, the cloud gaming server in the cloud is responsible for information processing. When playing a game, a player operates the client device to send operation instructions to the cloud gaming server. The cloud gaming server runs the game according to the operation instructions, encodes and compresses the game picture and other data, and returns it to the client device through a network. Finally, the client device decodes and outputs the game picture.

In some embodiments, taking a game as an example, a local terminal device stores a game program and is used for presenting the game picture. The local terminal device is used for interacting with a player through a graphical user interface, that is, downloading and installing the game program and running it in a conventional manner through an electronic device. The local terminal device may provide the graphical user interface to the player in a variety of manners including, for example, rendering and displaying it on a display screen of the terminal, or providing it to the player through holographic projection. For example, the local terminal device may include a display screen and a processor. The display screen is used for presenting a graphical user interface, the graphical user interface including a game picture. The processor is used for running the game, generating the graphical user interface, and controlling display of the graphical user interface on the display screen.

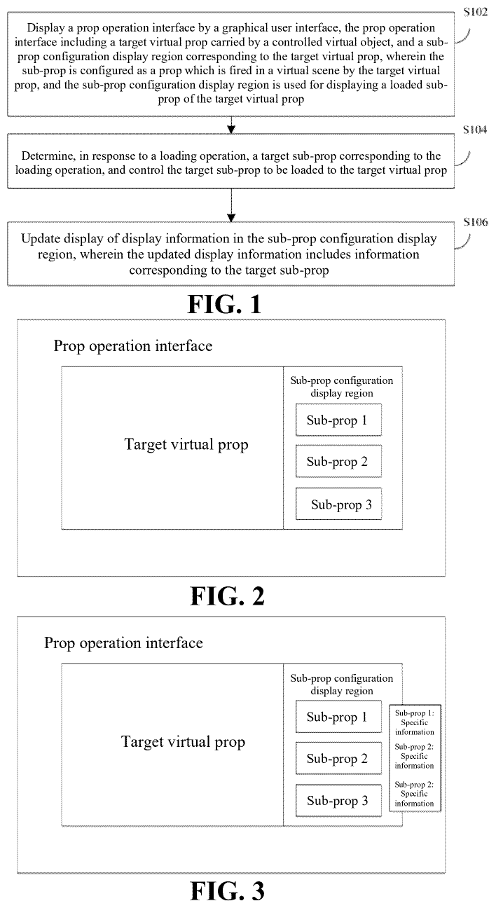

In a possible embodiment, the embodiments of the present disclosure provide an interaction control method for a virtual prop, where a graphical user interface is provided by means of a terminal device, and a prop operation interface is shown in FIG. 1. The method includes the following steps:

Step S102: Display a prop operation interface by the graphical user interface, the prop operation interface including a target virtual prop carried by a controlled virtual object, and a sub-prop configuration display region corresponding to the target virtual prop, where the sub-prop is configured as a prop which is fired (or discharged) in a virtual scene by the target virtual prop, and the sub-prop configuration display region is used for displaying a loaded sub-prop of the target virtual prop.

The target virtual prop may generally be a weapon or tool of the controlled virtual object, for example, the target virtual prop may be a bow, a gun, a cannon barrel, a tank, or another tool designated by a game creator for launching bullets or medicines. The sub-prop matches the target virtual prop and can be fired (or discharged) by the target virtual prop. When the target virtual prop is a bow, the sub-prop is an arrow; when the target virtual prop is a gun, the sub-prop is a bullet, and so on. The target virtual prop needs to be equipped with sub-props before use. The sub-props in the target virtual prop decrease as the target virtual prop is used. The target virtual prop usually cannot be used when there are no sub-props in it.

During the game operation, the player can cause the graphical user interface to display the prop operation interface by clicking a prop setting control in a game scene, or by pressing a preset keyboard key for triggering a prop setting function. The prop operation interface may display the target virtual prop carried by the controlled virtual object, and the sub-prop configuration display region corresponding to the target virtual prop. The sub-prop configuration display region usually displays information, such as identifiers and quantity, of sub-props loaded in the target virtual prop. As shown in FIG. 2, a sub-prop 1, a sub-prop 2, and a sub-prop 3 are displayed in the sub-prop configuration display region. When the target virtual prop is a gun, the sub-props, that is, the bullets, need to be placed in a magazine, and then the magazine is loaded to the gun. At this time, the content displayed in the sub-prop configuration display region is bullet information in the magazine loaded to the gun.

In some embodiments, the sub-prop configuration display region includes an identifier of the total quantity of target virtual sub-props that are loadable for the current target virtual prop. For example, when the target virtual prop is a firearm, the sub-prop configuration display region displays the total quantity of bullets that are loadable for the firearm.

In some embodiments, the target virtual prop is configured to be able to load an auxiliary prop to extend the upper limit of the total quantity of target virtual sub-props that are configurable for the target virtual prop. Taking an extended magazine prop as an example, when a default total quantity of bullets that are loadable in a firearm prop is 30, if the magazine prop is loaded on the firearm prop, the original total quantity of bullets that are loadable may be increased to 50. In this embodiment, the sub-prop configuration display region includes an identifier of the total quantity of target virtual sub-props that are loadable for the current target virtual prop after the auxiliary prop is loaded.

Step S104: Determine, in response to a loading operation, a target sub-prop corresponding to the loading operation, and control the target sub-prop to be loaded to the target virtual prop.

The loading operation is usually an operation performed by a player in the graphical user interface through a human-computer interaction device, such as a mouse, a keyboard, or a touch screen, connected to the terminal device. Specifically, different operations may be set according to different needs, for example, a click operation on the sub-prop configuration display region, a click operation on the target virtual prop, and the like. Different loading operations may be set. For example, through a first loading operation, to-be-loaded sub-props of a quantity and a type initiatively selected by the player may be loaded into the target virtual prop. Through a second loading operation, sub-props are loaded into the target virtual prop by a game system automatically based on a preset sub-prop loading order until the target virtual prop is filled.

When the loading operation of the player corresponds to selection by the player initiatively on a to-be-loaded sub-prop, the player first needs to select the to-be-loaded sub-prop from sub-props owned by the player. Generally speaking, the sub-props owned by the player may also be displayed in a prop operation window. Specifically, a sub-prop storage display region may be set in a virtual prop operation window to display the sub-props that are owned by the player and not loaded into the target virtual prop. The sub-prop storage display region may display the scene of a backpack or an equipment library to simulate a storage scene of sub-props in reality.

The player may use the human-computer interaction device to click on a display position of the sub-prop that he/she intends to load in the sub-prop storage display region to select the sub-prop, and then may long press a display region of the sub-prop so that the graphical user interface displays a loading control corresponding to the sub-prop. The loading operation may be a confirmation operation on the loading control. After selecting the sub-prop, the player may also directly drag a sub-prop icon to the sub-prop configuration display region through a drag operation, and at this point, the drag operation may be regarded as the loading operation. One or more sub-props may be selected by the player, depending on the needs of the player.

Generally speaking, after the player selects a sub-prop that he/she intends to load and generates a sub-prop loading event through an operation, the sub-prop that he/she intends to load may be used as a target sub-prop to be loaded to the target virtual prop. However, the target virtual prop may already have sub-props or have a small capacity, and its remaining capacity is less than the quantity of sub-props that the player intends to load. At this time, it is necessary to select, according to the remaining capacity of the target virtual prop, the target sub-prop from the sub-props that the player intends to load. Specifically, according to an order in which the player selects the sub-props, the sub-prop selected earlier may be selected as the target sub-prop from the sub-props that the player intends to load. The quantity of target sub-props matches the remaining capacity of the target virtual prop. In addition, the target virtual prop may have different types of sub-props that are loadable under different configurations, and therefore, it may be set that the player cannot select sub-props that cannot be loaded to the target virtual prop, or after selection by the player, a prompt identifier is displayed and the system automatically cancels the selection operation.

When it is required that the system automatically loads sub-props into the target virtual prop, the player may trigger the loading control in the sub-prop configuration display region by double-clicking the region, long pressing the region, or the like. Then, the player may perform a confirmation operation on the loading control, such as clicking the loading control, which may be regarded as the loading operation. After the sub-prop loading event is generated, the sub-prop loading logic of the game system may be pre-set to automatically load sub-props into the target virtual prop based on a preset sub-prop loading order, such as first loading sub-props with greater penetration or lethality. Therefore, non-loaded sub-props possessed by the player may be sorted according to preset sub-prop parameters, and a sub-prop that matches the remaining capacity of the target virtual prop may be selected from the sorting result and regarded as the target sub-prop. The above loading logic may also be loading according to the player's preference, such as using a sub-prop with a higher firing frequency as the to-be-loaded sub-prop based on historical sub-prop firing records.

In the process of loading the target sub-prop to the target virtual prop, a preset special effect may be displayed on the graphical user interface. The special effect may include an animation effect of loading the sub-prop into the target virtual prop, a sound effect, and the like. A display duration of the preset special effect may be determined according to the quantity of target sub-props and is proportional to the quantity of target sub-props. The preset special effect may be displayed at a display position of the target virtual prop in the virtual prop configuration window, thereby providing a more realistic sub-prop loading experience to players.

Step S106: Update display of display information in the sub-prop configuration display region, where the updated display information includes information corresponding to the target sub-prop.

After the target sub-prop is loaded to the target virtual prop, loaded sub-props in the target virtual prop are changed, so that the display content of the sub-prop configuration display region also needs to be updated along with the loaded sub-props in the target virtual prop. The updated sub-prop configuration display region displays information corresponding to the loaded sub-props in the target virtual prop. At this time, the target sub-prop may be displayed as a loaded sub-prop in the sub-prop configuration display region.

During displaying of the loaded sub-props in the sub-prop configuration display region, only sub-prop identifiers may be displayed according to a loading order, or the sub-prop type and quantity may be displayed at the same time. If a plurality of sub-props of the same type are installed contiguously, only one sub-prop identifier may be displayed, and the quantity of sub-props corresponding to the sub-prop identifier may be displayed at the same time. When the sub-prop configuration display region only displays the sub-prop identifier, by clicking the region or causing a mouse cursor hovering over the region, the graphical user interface is caused to display specific information such as the type, quantity, and lethality of the loaded sub-props, as shown in FIG. 3.

An interaction control method for a virtual prop as described above responds to the sub-prop loading event for the target virtual prop, determines the target sub-prop to be loaded into the target virtual prop, displays the preset special effect of loading the target sub-prop into the target virtual prop, and updates the display of the loaded sub-props in the sub-prop configuration display region, where the target sub-prop is displayed in the sub-prop configuration display region after the display is updated. While ensuring the use feeling of a player on the target virtual prop, the method simplifies the sub-prop loading process, thereby improving the user experience.

An implementation of determining, in response to a loading operation, a target sub-prop corresponding to the loading operation is provided in the following embodiment.

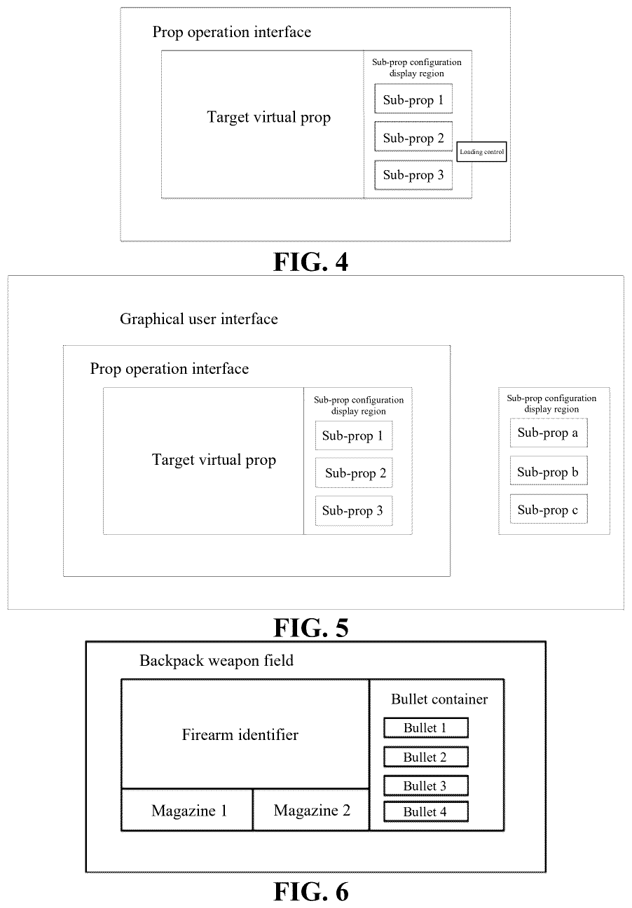

When it is required that the system automatically loads sub-props into the target virtual prop, the loading operation may be triggering the loading control. Specifically, the player may click on the sub-prop configuration display region through the human-computer interaction device, and in response to the click operation on the sub-prop configuration display region, the loading control is displayed, as shown in FIG. 4. In response to a trigger operation on the loading control, the target sub-prop corresponding to the trigger operation is determined.

During determining of the target sub-prop corresponding to the trigger operation, the sub-props in a sub-prop storage equipment of the controlled virtual object controlled by the player are needed. These sub-props are not loaded into the target virtual props and may be referred to as non-loaded sub-props. The graphical user interface may also include a sub-prop storage display region. The sub-prop storage display region is used for displaying the non-loaded sub-props in the sub-prop storage equipment of the controlled virtual object, as shown in FIG. 5.

Specifically, the quantity of target sub-props may be determined first, in response to the trigger operation on the loading control, based on a remaining capacity of the target virtual prop and a quantity of non-loaded sub-props. When the remaining capacity is greater than the quantity of non-loaded sub-props, the quantity of non-loaded sub-props is determined as the quantity of target sub-props, and when the remaining capacity is less than the quantity of non-loaded sub-props, the remaining capacity is determined as the quantity of target sub-props. The non-loaded sub-props are sorted from large to small according to penetration parameters of the non-loaded sub-props to obtain a sorting result. The non-loaded sub-props are selected in sequence according to the sorting result until the quantity of selected non-loaded sub-props is equal to the quantity of target sub-props. Finally, the selected non-loaded sub-props are determined as the target sub-props.

When the player needs to initiatively select the sub-prop that he/she intends to load into the target virtual prop, the sub-prop loading event may be a drag operation on the non-loaded sub-prop. When the player selects a non-loaded sub-prop in the sub-prop storage display region, in response to the selection operation on the non-loaded sub-prop in the sub-prop storage display region, the non-loaded sub-prop corresponding to the selection operation is determined as a target non-loaded sub-prop. In response to a drag operation on the target non-loaded sub-prop, the target sub-prop to be loaded into the target virtual prop is determined based on the remaining capacity of the target virtual prop and the quantity of target non-loaded sub-props. An end position of the drag operation is located in the sub-prop configuration display region.

The remaining capacity may indicate the quantity of sub-props that are loadable into the target virtual prop. During determining of the target sub-prop to be loaded into the target virtual props, a smaller one of the quantity of loadable sub-props of the target virtual props and the quantity of target non-loaded sub-props may be determined as the quantity of target sub-props. The target non-loaded sub-props are selected in sequence according to a selection order of the target non-loaded sub-props until the quantity of selected target non-loaded sub-props is equal to the quantity of target sub-props. The above selection order may be determined based on the selection operation. Finally, the selected target non-loaded sub-props are determined as the target sub-props.

The sub-prop storage display region usually includes a plurality of sub-regions, and each sub-region is used for displaying a non-loaded sub-prop. The same sub-region is usually used for displaying the same type of non-loaded sub-props. Non-loaded sub-props in a sub-region may be split into other sub-regions. The sub-region that requires splitting may be referred to as a first sub-region, and the sub-region to which splitting is performed may be referred to as a second sub-region. There may be a plurality of second sub-regions. The first sub-region displays a first quantity of non-loaded sub-props, for example, 20 bullets.

The player may perform an operation such as clicking or long pressing on the first sub-region, and these operations may be regarded as split operations. In response to the split operation on the non-loaded sub-props in the first sub-region, a quantity input window corresponding to the non-loaded sub-props in the first sub-region is displayed, and the player may edit and generate a number in the quantity input window through the human-computer interaction device. The number is the quantity of sub-props corresponding to the edit operation. In response to the edit operation on the quantity input window, the quantity of sub-props corresponding to the edit operation is displayed, and the quantity of sub-props is the quantity of non-loaded sub-props split to the second sub-region.

The quantity input window includes a confirmation control. When the player selects the confirmation control, in response to the selection operation on the confirmation control, the quantity input window is canceled. Based on the quantity of sub-props, the first quantity of non-loaded sub-props in the first sub-region is controlled to be updated, and the non-loaded sub-props of the quantity of sub-props are displayed in the second sub-region. For example, when the quantity of sub-props corresponding to the edit operation is 10, the first quantity of non-loaded sub-props in the first sub-region is changed from 20 to 10. If there are originally no non-loaded sub-props in the second sub-region, the quantity of non-loaded sub-props in the second sub-region is 10.

The player may split the quantity of non-loaded sub-props in the sub-region of the sub-prop storage display region as needed, so that during loading, the player may directly select the non-loaded sub-props in the sub-region whose quantity meets his/her own needs, and drag them to the sub-prop configuration display region to realize the loading of the non-loaded sub-props.

In some cases, the target virtual prop has a detachable loading accessory for loading a sub-prop. For example, a gun has a magazine, bullets need to be loaded into the magazine, and then the magazine is loaded to the gun so that the bullets can be used in the gun. Magazines may have different parameters, such as capacity and compatible bullet types, and therefore, when different magazines are used, the types of bullets that are compatible with the gun are also different. The sub-region of the sub-prop storage display region may also display the loading accessory that is possessed by the controlled virtual object and matches the target virtual prop. Based on the loading operation of the player on the loading accessory in the sub-region, the non-loaded sub-props in the sub-region of the sub-prop storage display region may be loaded to the loading accessory in the sub-region, and then based on the drag operation of the player on the loading accessory with the sub-props loaded, the loading accessory is loaded into the target virtual prop, and then the sub-props in the loading accessory loaded into the target virtual prop are displayed in the sub-prop configuration display region. At the same time, the sub-props in the target virtual prop before the drag operation of the player on the loading accessory with the sub-props loaded need to be displayed in the sub-prop storage display region, indicating that these sub-props have been put back into the storage equipment.

In addition, the player may also initiatively set the quantity of sub-props loaded to the target virtual props as needed. Since the sub-prop storage display region usually displays the prop identifier and quantity information of the non-loaded sub-props in the prop storage equipment of the controlled virtual object, for example, the quantity of the first sub-props is 20 and the quantity of the second sub-props is 50, the player may select the prop identifier of a sub-prop as needed. In response to a selection operation on a prop identifier of a non-loaded sub-prop in the sub-prop storage display region, such as a selection operation on the player on the prop identifier of the first sub-prop, a target loading quantity input window corresponding to the non-loaded sub-prop is displayed. In response to an edit operation on the target loading quantity input window, editing content corresponding to the edit operation is determined as the target quantity of the target sub-props, and based on the editing content and quantity information, the quantity information of the non-loaded sub-props displayed in the sub-prop storage display region is updated. The above edit operation may be that the player enters a number, that is, the editing content mentioned above, into the window through the human-computer interaction device, and the number represents the quantity of sub-props that the player intends to be loaded to the target virtual prop, that is, the target quantity mentioned above, and the target quantity is subtracted from the quantity of the non-loaded sub-props displayed in the sub-prop storage display region to obtain the updated quantity of sub-props. Finally, the non-loaded sub-props of a quantity matching the target quantity may be determined as target sub-props, and then the target sub-props are loaded to the target virtual prop.

In the process of the player dragging the target non-loaded sub-prop, different display effects of the sub-prop configuration display region may be displayed based on the position of a trajectory of the drag operation. If it is monitored that the trajectory of the drag operation is located in the sub-prop storage display region, it may be determined whether the target non-loaded sub-prop matches the target virtual prop. Specifically, it may be determined whether the quantity of the target non-loaded sub-props is less than the remaining capacity of the target virtual prop, and whether the target non-loaded sub-prop is loadable into the target virtual prop. If both are met, it may be determined that the target non-loaded sub-prop matches the target virtual prop.

The above sub-props usually correspond to a plurality of prop types. The target virtual prop matches the sub-prop corresponding to the target prop type, and the target prop type includes one or more prop types. For example, a certain type of bow can only match arrows of a certain size, and a certain model of gun can only be loaded with a few preset types of bullets. When determining whether the target non-loaded sub-prop matches the target virtual prop, it may be determined whether a prop type corresponding to the target non-loaded sub-prop belongs to the target prop type corresponding to the target virtual prop; if yes, it is determined that the target non-loaded sub-prop matches the target virtual prop; and if no, it is determined that the target non-loaded sub-prop does not match the target virtual prop.

If they match, the sub-prop configuration display region may be controlled to be displayed in a first display format, where the first display format indicates that the sub-prop configuration display region is in an interactive state, for example, the edge of the sub-prop configuration display region is highlighted. If they do not match, the sub-prop configuration display region is controlled to be displayed in a second display format, where the second display format indicates that the sub-prop configuration display region is in a disabled state, for example, the sub-prop configuration display region is displayed in gray.

If it is monitored that the trajectory of the drag operation is located in the sub-prop configuration display region, the sub-prop configuration display region is controlled to be displayed in a third display format. The third display format indicates that the sub-prop configuration display region is in an interactive response state, for example, the edge of the sub-prop configuration display region may be in a shaking state. If an end event of the drag operation is monitored, the display of the sub-prop configuration display region in the third display format is canceled.

An implementation of updating the display of the loaded sub-props in the sub-prop configuration display region is provided in the following embodiment.

During displaying of the loaded sub-props of the target virtual prop through the sub-prop configuration display region, in order to save space, sub-prop identifiers of the updated loaded sub-props may be displayed in the sub-prop configuration display region according to a loading order of the updated loaded sub-props. The updated loaded sub-props include the target sub-prop. In the specific implementation, sub-props usually correspond to a plurality of types. The prop identifier of the sub-prop corresponds to the type of the sub-prop, that is, different types of sub-props have different prop identifiers. By checking the identifiers of the sub-props displayed in the sub-prop configuration display region, it may be known which types of sub-props are loaded in the target virtual prop.

There may be a variety of types and quantities of sub-props loaded in the target virtual prop, which are difficult to be displayed in one page, and therefore, the loaded sub-props may be divided into at least one prop display group based on a preset display quantity and the loading order of the updated loaded sub-props, where the prop display group includes at least one loaded sub-prop, and the quantity of loaded sub-props in the prop display group is less than or equal to the display quantity. Then, a target prop display group is determined from the at least one prop display group based on the loading order of the loaded sub-props, and the prop identifiers of the loaded sub-props are displayed in the target prop display group in the sub-prop configuration display region. Generally, prop identifiers of several last loaded sub-props are displayed. In response to a hover operation on the sub-prop configuration display region, a next target prop display group of the target prop display group is determined from the at least one prop display group, and the prop identifiers of the loaded sub-props in the next target prop display group are displayed in the sub-prop configuration display region. Specifically, various prop display groups may be displayed according to a display order that is opposite to the loading order.

During the specific implementation, the sub-props loaded later are usually fired (or discharged) first, and therefore, in order to display the firing order of the sub-props, the display order of the loaded sub-props in the sub-prop configuration display region is usually opposite to the loading order of the loaded sub-props, that is, the display position of the sub-prop loaded first is the last position of the loaded sub-props. When the player generates a firing (or discharge) operation on a target virtual prop through the human-computer interaction device, in response to the firing (or discharge) operation on the target virtual prop, a target fire sub-prop corresponding to the firing operation is determined based on the display order of the loaded sub-props, and the target virtual prop is controlled to fire the target fire sub-prop in the virtual scene. For example, the last loaded bullet may be fired (or discharged) through a gun.

In addition, the player may also change the display order of the sub-props by dragging the prop identifier of the sub-prop in the sub-prop configuration display region. For example, when the player drags the first sub-prop, in response to the drag operation on a prop identifier of the first sub-prop among the plurality of loaded sub-props, the prop identifiers of the loaded sub-props in the sub-prop configuration display region are updated based on a display position of a second sub-prop corresponding to an end position of the drag operation, where the prop identifier of the first sub-prop among the updated prop identifiers is displayed at the end position of the drag operation. The prop identifiers of other props located between the first sub-prop and the second sub-prop and of the second sub-prop may be moved up in sequence; or only the display positions of the first sub-prop and the second sub-prop may be exchanged, which may be set specifically according to needs.

When the player causes a mouse cursor hover over the sub-prop configuration display region, in response to the hover operation on the sub-prop configuration display region, the quantity and type of the updated loaded sub-props may be displayed in the graphical user interface, and their lethality parameters may also be displayed, as shown in FIG. 3.

In addition, when needing to unload ammunition, the player may click or long press the sub-prop configuration display region, and in response to the operation on the sub-prop configuration display region, an ammunition unloading control is displayed. In response to a selection operation on the ammunition unloading control, it is determined whether the remaining capacity of the sub-prop storage equipment is greater than the quantity of loaded sub-props in the target virtual prop. If the remaining capacity is greater, the loaded sub-props are determined as unloaded sub-props. Then, the display effect of the sub-prop configuration display region is updated, where the updated display effect indicates that the loaded sub-props in the target virtual props are empty. The display of the non-loaded sub-props in the sub-prop storage display region is updated, where the unloaded sub-props are displayed in the sub-prop configuration display region after the display is updated.

The embodiments of the present disclosure further provides another interaction control method for a virtual prop, and the method is implemented based on the method shown in FIG. 1. In the method, the target virtual prop is set as a firearm, and the sub-prop configuration display region is referred to as a bullet container. The method adds a bullet container to each firearm, with different capacity limits, that is, quantities of loadable bullets. The capacity of the bullet container of the same gun may vary, which may specifically be determined based on a capacity parameter of the modified magazine. The bullet container records the loading order of each bullet and displays the first n bullets in order on the interface. The bullet container is loaded and consumed in a stack manner, that is, the bullet loaded first is fired (or discharged) later, and the bullet loaded later is fired (or discharged) first. In the method, types and quantities of bullets loaded in the bullet container may be checked through interaction, and loading may be performed through interaction on the graphical user interface, which is the same as the effect of loading using a shortcut key in a battle interface.

In the method, the firearm per se can be used and fire bullets directly without any accessory, that is, it is considered that the firearm per se has its own magazine, and as long as there are “available” bullets in the backpack (equivalent to the above “bullet storage equipment”), the gun can be loaded with bullets. The available bullets refer to that the types of bullets are suitable for the firearm. The bullet prop grid in the backpack can be stacked, and can be split into several grids with different stacking quantities, so that it is convenient for the player to load bullets in units of grids. In the game, after installing the magazine accessory, the firearm can modify the maximum upper limit of bullets or increase the loading speed, and the player can use bullet containers to mix different bullets.

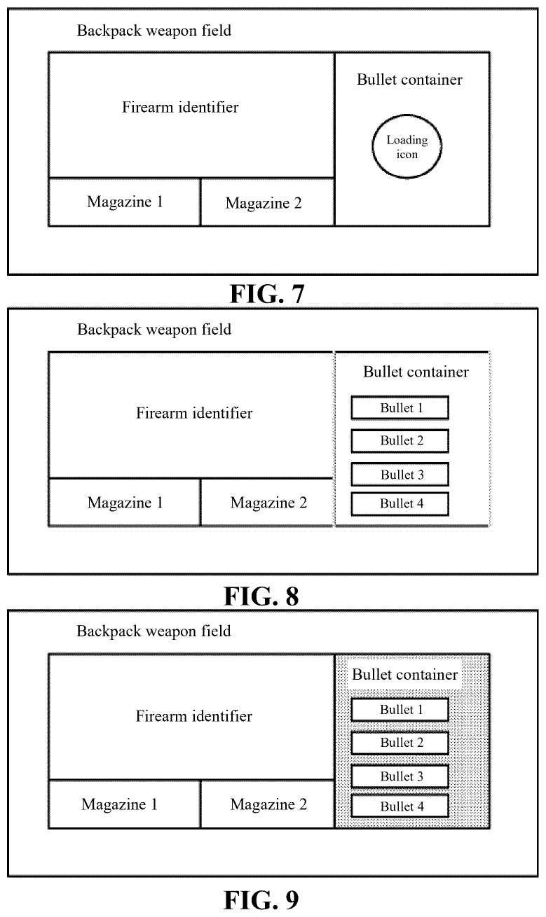

In one embodiment, the prop operation interface is referred to as a backpack weapon field, and the non-loaded sub-props are referred to as “spare bullets”. As shown in FIG. 6, a bullet container may be added to the backpack weapon field, displayed to the right of a firearm icon, and an identifier of the magazine it possesses is also displayed below the firearm icon. The bullet container may further display the quantity of bullets in the container and the quantity of spare bullets in the backpack. When the mouse hovers over the bullet container, a filling state is displayed, indicating the bullet type and quantity. When a bullet is dragged in or the shortcut key in the battle interface is used for loading, it takes a while for loading. This process is also referred to as loading. The bullet container displays a loading icon, as shown in FIG. 7.

In the backpack interface, bullets may be dragged into from other containers (warehouses, loot boxes, and items carried by the player himself/herself) to complete loading. There is no limit to the quantity of bullets that are loaded at a time as long as the maximum capacity is not exceeded. If a firearm can use several types of bullets, all of them are loadable, and the order in which they are loaded is not limited. The server may record this order and issue it in the loading order when firing.

When a bullet is dragged from another container, if the bullet type matches the firearm, the bullet container may display an interactive prompt, and the edge of the bullet container may have a shadow effect, as shown in FIG. 8. When the bullet is dragged onto the bullet container UI, an interactive response may be displayed, and the bullet container may be displayed as a highlight effect, as shown in FIG. 9. In FIG. 9, the highlight effect is represented by gray. The left mouse button is released at this point to complete the loading process. If the dragged item type does not match/the quantity exceeds the upper limit, it may be displayed in a disabled state. Releasing the left mouse button at this point has no effect.

In addition, right-click is further performed on the bullet container to pop up an option menu. The menu contains an option of [Unload Ammunition]. By clicking [Unload Ammunition], the bullets are unloaded back to the empty space in the backpack. If there is no empty space in the backpack, an error prompt may be provided and the unloading may fail.

There are two ways of loading bullets into the bullet container: automatic loading by the system and selecting and loading by the player.

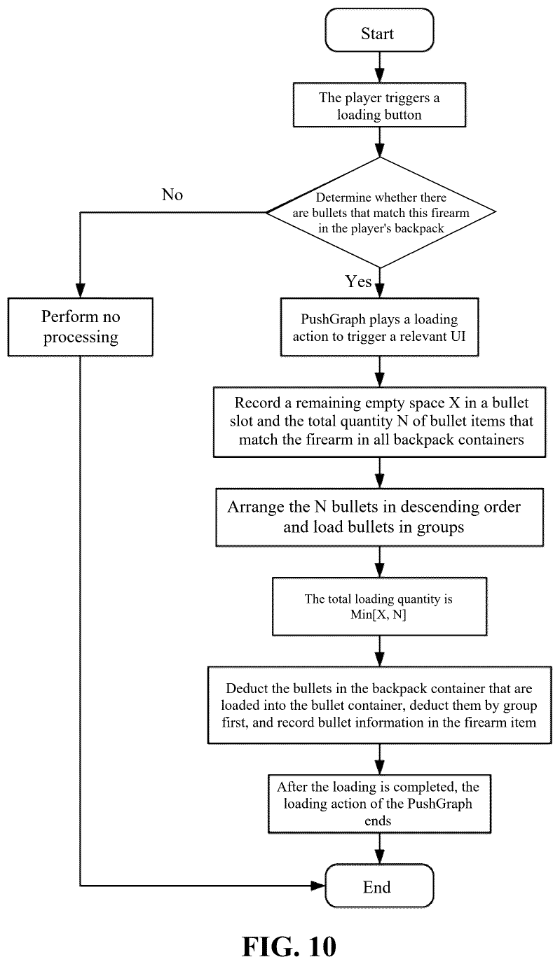

When the system automatically loads bullets, as shown in FIG. 10, the specific process is as follows: a. The player triggers a loading button; b. Determine whether there are bullets that match this firearm in the player's backpack; c. If not, no processing is performed; and if so, perform d; d. PushGraph plays a loading action to trigger a relevant UI; e. Record a remaining empty space X in a bullet slot and the total quantity N of bullet items that match the firearm in all backpack containers; f. Arrange the N bullets in descending order in terms of a Penetration field in spell and load them in groups; g. The total loading quantity is Min [X, N]; h. Deduct the bullets in the backpack container that are loaded into the bullet container, deduct them by group first, and record bullet information in the firearm item; and i. After the loading is completed, the loading action of the PushGraph ends.

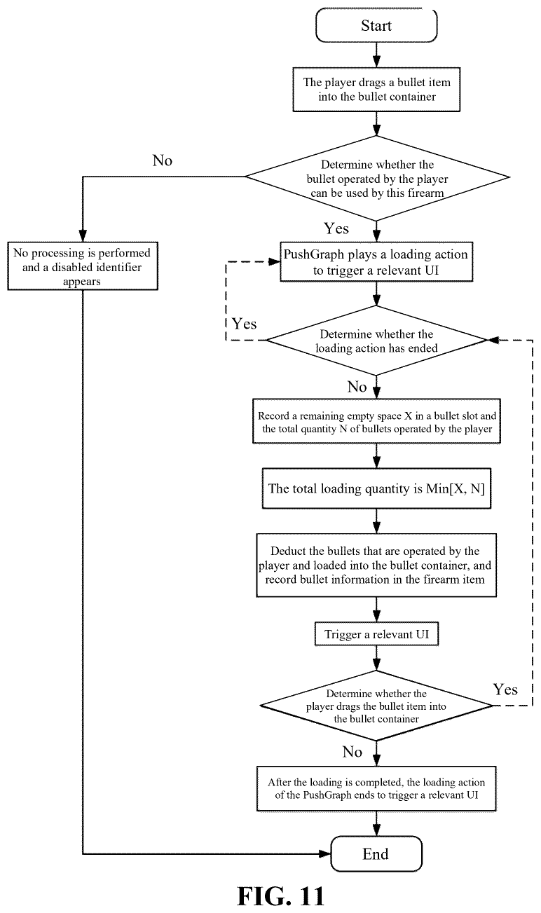

When the player selects and loads bullets, as shown in FIG. 11, the specific process is as follows: a. The player drags a bullet item into the bullet container; b. Determine whether the bullet operated by the player can be used by this firearm; c. If not, no processing is performed and a disabled identifier appears; d. PushGraph plays a loading action to trigger a relevant UI; e. Determine whether the loading action has ended, if not, perform d, and if so, perform f; f. Record a remaining empty space X in a bullet slot and the total quantity N of bullets operated by the player; g. The total loading quantity is Min [X, N]; h. Deduct the bullets that are operated by the player and loaded into the bullet container, and record bullet information in the firearm item; i. Trigger a relevant UI; j. Determine whether the player drags the bullet item into the bullet container, and if yes, perform b; if no, perform k; and k. After the loading is completed, the loading action of the PushGraph ends to trigger a relevant UI.

The above method provides an interactive feeling of firearm modification and bullet loading, which provides realistic experience, provides the function of mixing different types of bullets, and visually presents the bullet information in the firearm on the graphical user interface, thereby enriching the tactical strategy of the player. Moreover, the player only needs to perform one step to load bullets, thereby ensuring the efficiency.

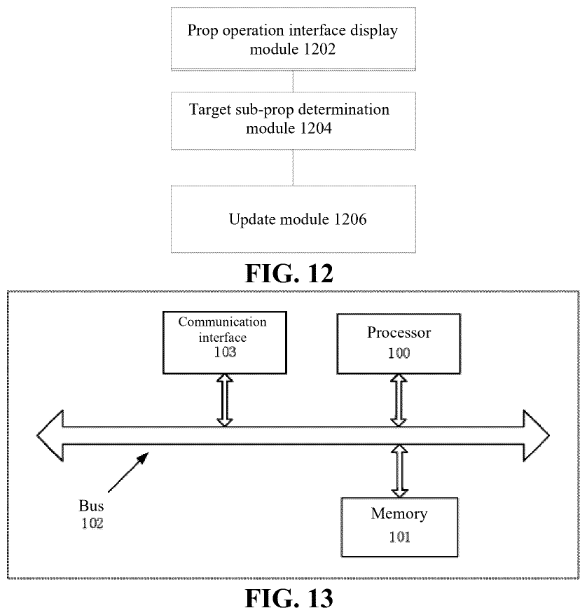

For the above method embodiment, an interaction control apparatus for a virtual prop referring to FIG. 12 provides a graphical user interface by means of a terminal device. The apparatus includes:
a prop operation interface display module 1202 used for displaying a prop operation interface by the graphical user interface, the prop operation interface including a target virtual prop carried by a controlled virtual object, and a sub-prop configuration display region corresponding to the target virtual prop, where the sub-prop is configured as a prop discharged in a virtual scene by the target virtual prop, and the sub-prop configuration display region is used for displaying a loaded sub-prop of the target virtual prop;
a target sub-prop determination module 1204 used for determining, in response to a loading operation, a target sub-prop corresponding to the loading operation, and controlling the target sub-prop to be loaded to the target virtual prop; and
an update module 1206 used for updating display of display information in the sub-prop configuration display region, where the updated display information includes information corresponding to the target sub-prop.

For the above interaction control apparatus for a virtual prop, a prop operation interface is displayed by a graphical user interface, the prop operation interface including a target virtual prop carried by a controlled virtual object, and a sub-prop configuration display region corresponding to the target virtual prop, where the sub-prop is configured as a prop discharged in a virtual scene by the target virtual prop, and the sub-prop configuration display region is used for displaying a loaded sub-prop of the target virtual prop. A target sub-prop corresponding to a loading operation is determined in response to the loading operation, and the target sub-prop is controlled to be loaded to the target virtual prop. Display of display information in the sub-prop configuration display region is updated, where the updated display information includes information corresponding to the target sub-prop. While ensuring the use feeling of a player on the target virtual prop, the method simplifies the sub-prop loading process, thereby improving the user experience.

The above loading operation includes a trigger operation on a loading control; and the target sub-prop determination module is used for displaying the loading control in response to a click operation on the sub-prop configuration display region; and determining, in response to the trigger operation on the loading control, a target sub-prop corresponding to the trigger operation.

The graphical user interface further includes a sub-prop storage display region, and the sub-prop storage display region is used for displaying non-loaded sub-props in a prop storage equipment of the controlled virtual object. The target sub-prop determination module is used for determining, in response to the trigger operation on the loading control, a quantity of the target sub-props based on a remaining capacity of the target virtual prop and a quantity of non-loaded sub-props; sorting the non-loaded sub-props from large to small according to penetration parameters of the non-loaded sub-props to obtain a sorting result; selecting the non-loaded sub-props in sequence according to the sorting result until the quantity of selected non-loaded sub-props is equal to the quantity of target bullets; and determining the selected non-loaded sub-props as the target sub-props.

The graphical user interface further includes a sub-prop storage display region, and the sub-prop storage display region is used for displaying non-loaded sub-props in a prop storage equipment of the controlled virtual object. The target sub-prop determination module is used for determining, in response to a selection operation on a non-loaded sub-prop in the sub-prop storage display region, the non-loaded sub-prop corresponding to the selection operation as a target non-loaded sub-prop; and determining, in response to a drag operation on the target non-loaded sub-prop, the target sub-prop to be loaded to the target virtual prop based on a remaining capacity of the target virtual prop and a quantity of the target non-loaded sub-props, where an end position of the drag operation is located in the sub-prop configuration display region.

The remaining capacity indicates a quantity of sub-props that are loadable to the target virtual prop. The target sub-prop determination module is used for determining a smaller one of the quantity of sub-props that are loadable to the target virtual prop and the quantity of the target non-loaded sub-props as the quantity of target sub-props; selecting the target non-loaded sub-props in sequence according to an order in which the target non-loaded sub-props are selected until the quantity of selected target non-loaded sub-props is equal to the quantity of target bullets; and determining the selected target non-loaded sub-props as the target sub-props.

The sub-props correspond to a plurality of types, a prop identifier of the sub-prop corresponds to the type of the sub-prop, and the display information includes the prop identifiers and quantity of the loaded sub-props. The update module is used for displaying, in the sub-prop configuration display region, prop identifiers of the updated loaded sub-props according to a loading order of the updated loaded sub-props, where the updated loaded sub-props include the target sub-prop.

A display order of the loaded sub-props in the sub-prop configuration display region is opposite to a loading order of the loaded sub-props. The apparatus further includes: a firing module used for determining, in response to a firing (or discharge) operation on the target virtual prop, a target fire sub-prop corresponding to the firing operation based on the display order of the loaded sub-props, and controlling the target virtual prop to fire the target fire sub-prop in the virtual scene.

The above apparatus further includes a quantity display module used for displaying, in response to a hover operation on the sub-prop configuration display region, a quantity and type of the updated loaded sub-props.

The graphical user interface further includes a sub-prop storage display region, and the sub-prop storage display region is used for displaying non-loaded sub-props in a prop storage equipment of the controlled virtual object. The apparatus further includes: an unloading module used for displaying an unloading control in response to a click operation on the sub-prop configuration display region; a quantity determination module used for determining, in response to a selection operation on the unloading control, whether a remaining capacity of the prop storage equipment is greater than or equal to the quantity of loaded sub-props in the target virtual prop; an unloaded sub-prop determination module used for determining the loaded sub-prop as an unloaded sub-prop if the remaining capacity is greater than the quantity of loaded sub-props; a configuration effect update module used for updating a display effect of the sub-prop configuration display region, where the updated display effect indicates that the loaded sub-prop in the target virtual prop is empty; and a storage effect update module used for updating display of non-loaded bullets in the sub-prop storage display region, where the unloaded sub-prop is displayed in the sub-prop configuration display region after the display is updated.

The apparatus further includes: a matching determination module used for determining, if it is monitored that a trajectory of the drag operation is located in the sub-prop storage display region, whether the target non-loaded sub-prop matches the target virtual prop; a first format display module used for controlling, if they match, the sub-prop configuration display region to be displayed in a first display format, where the first display format indicates that the sub-prop configuration display region is in an interactive state; a second format display module used for controlling, if they do not match, the sub-prop configuration display region to be displayed in a second display format, where the second display format indicates that the sub-prop configuration display region is in a disabled state; a third format display module used for controlling, if it is monitored that a trajectory of the drag operation is located in the sub-prop configuration display region, the sub-prop configuration display region to be displayed in a third display format, where the third display format indicates that the sub-prop configuration display region is in an interactive response state; and a format canceling display module used for canceling, if an end event of the drag operation is monitored, the display of the sub-prop configuration display region in the third display format.

The sub-props correspond to a plurality of prop types, the target virtual prop matches a sub-prop corresponding to a target prop type, and the target prop type includes one or more prop types. The matching determination module is further used for determining whether a prop type corresponding to the target non-loaded sub-prop belongs to the target prop type corresponding to the target virtual prop; determining, if yes, that the target non-loaded sub-prop matches the target virtual prop; and determining, if no, that the target non-loaded sub-prop does not match the target virtual prop.

The display information includes prop identifiers of a plurality of loaded sub-props. The apparatus further includes a position update module used for updating, in response to a drag operation on a prop identifier of a first sub-prop among the plurality of loaded sub-props, display of the prop identifiers of the loaded sub-props in the sub-prop configuration display region based on a display position of a second sub-prop corresponding to an end position of the drag operation, where the prop identifier of the first sub-prop among the updated prop identifiers is displayed at the end position of the drag operation.

The sub-prop storage display region includes a first sub-region and at least one second sub-region, and the first sub-region displays non-loaded sub-props having a first quantity. The apparatus further includes: a first quantity window display module used for displaying, in response to a split operation on the non-loaded sub-props in the first sub-region, a quantity input window corresponding to the non-loaded sub-props in the first sub-region; a sub-prop quantity display module used for displaying, in response to an edit operation on the quantity input window, a quantity of sub-props corresponding to the edit operation, where the quantity input window includes a confirmation control; a window display cancel module used for canceling, in response to a selection operation on the confirmation control, the display of the quantity input window; and a quantity update module used for controlling, based on the quantity of sub-props, update of the first quantity of non-loaded sub-props in the first sub-region, and displaying the non-loaded sub-props having the quantity of sub-props in the second sub-region.

The update module is further used for dividing the loaded sub-props into at least one prop display group based on a preset display quantity and the loading order of the updated loaded sub-props, where the prop display group includes at least one loaded sub-prop, and the quantity of loaded sub-props in the prop display group is less than or equal to the display quantity; determining a target prop display group from the at least one prop display group based on the loading order of the loaded sub-props, and displaying the prop identifiers of the loaded sub-props in the target prop display group in the sub-prop configuration display region; and determining, in response to a hover operation on the sub-prop configuration display region, a next target prop display group of the target prop display group from the at least one prop display group, and displaying the prop identifiers of the loaded sub-props in the next target prop display group in the sub-prop configuration display region.

The graphical user interface further includes a sub-prop storage display region, and the sub-prop storage display region displays the prop identifiers and quantity information of non-loaded sub-props in a prop storage equipment of the controlled virtual object. The target sub-prop determination module is further used for displaying, in response to a selection operation on the prop identifier of the non-loaded sub-prop in the sub-prop storage display region, a target loading quantity input window corresponding to the non-loaded sub-prop; determining, in response to an edit operation on the target loading quantity input window, editing content corresponding to the edit operation as a target quantity of the target sub-props, and updating the quantity information of the non-loaded sub-props displayed in the sub-prop storage display region based on the editing content and the quantity information; and determining the non-loaded sub-prop of a quantity matching the target quantity as the target sub-prop.

This embodiment further provides an electronic device including a processor and a memory, where machine-executable instructions executable by the processor are stored in the memory, and the processor executes the machine-executable instructions to implement the above interaction control method for a virtual prop, for example:

The method provides a graphical user interface by means of a terminal device, the graphical user interface displays a prop operation interface, the prop operation interface including a target virtual prop carried by a controlled virtual object, and a sub-prop configuration display region corresponding to the target virtual prop, where the sub-prop is configured as a prop which is fired in a virtual scene by the target virtual prop, and the sub-prop configuration display region is used for displaying a loaded sub-prop of the target virtual prop. A target sub-prop corresponding to a loading operation is determined in response to the loading operation, and the target sub-prop is controlled to be loaded to the target virtual prop. Display of display information in the sub-prop configuration display region is updated, where the updated display information includes information corresponding to the target sub-prop.

While ensuring the use feeling of a player on the target virtual prop, the method simplifies the sub-prop loading process, thereby improving the user experience.

In some embodiments, the above loading operation includes a trigger operation on a loading control. The step of determining, in response to a loading operation, a target sub-prop corresponding to the loading operation includes: displaying the loading control in response to a click operation on the sub-prop configuration display region; and determining, in response to the trigger operation on the loading control, a target sub-prop corresponding to the trigger operation.

In some embodiments, the graphical user interface further includes a sub-prop storage display region, and the sub-prop storage display region is used for displaying non-loaded sub-props in a prop storage equipment of the controlled virtual object. The step of determining, in response to the trigger operation on the loading control, a target sub-prop corresponding to the trigger operation includes: determining, in response to the trigger operation on the loading control, a quantity of the target sub-props based on a remaining capacity of the target virtual prop and a quantity of non-loaded sub-props; sorting the non-loaded sub-props from large to small according to penetration parameters of the non-loaded sub-props to obtain a sorting result; selecting the non-loaded sub-props in sequence according to the sorting result until the quantity of selected non-loaded sub-props is equal to the quantity of target bullets; and determining the selected non-loaded sub-props as the target sub-props.

In some embodiments, the graphical user interface further includes a sub-prop storage display region, and the sub-prop storage display region is used for displaying non-loaded sub-props in a prop storage equipment of the controlled virtual object. The step of determining, in response to a loading operation, a target sub-prop corresponding to the loading operation includes: determining, in response to a selection operation on a non-loaded sub-prop in the sub-prop storage display region, the non-loaded sub-prop corresponding to the selection operation as a target non-loaded sub-prop; and determining, in response to a drag operation on the target non-loaded sub-prop, the target sub-prop to be loaded to the target virtual prop based on a remaining capacity of the target virtual prop and a quantity of the target non-loaded sub-props, where an end position of the drag operation is located in the sub-prop configuration display region.

In some embodiments, the remaining capacity indicates a quantity of sub-props that are loadable to the target virtual prop. The step of determining the target sub-prop to be loaded to the target virtual prop based on a remaining capacity of the target virtual prop and a quantity of the target non-loaded sub-props includes: determining a smaller one of the quantity of sub-props that are loadable to the target virtual prop and the quantity of the target non-loaded sub-props as the quantity of target sub-props; selecting the target non-loaded sub-props in sequence according to an order in which the target non-loaded sub-props are selected until the quantity of selected target non-loaded sub-props is equal to the quantity of target bullets; and determining the selected target non-loaded sub-props as the target sub-props.

In some embodiments, the sub-props correspond to a plurality of types, a prop identifier of the sub-prop corresponds to the type of the sub-prop, and the display information includes the prop identifiers and quantity of the loaded sub-props. The step of updating display of display information in the sub-prop configuration display region includes: displaying, in the sub-prop configuration display region, prop identifiers of the updated loaded sub-props according to a loading order of the updated loaded sub-props, where the updated loaded sub-props include the target sub-prop.

In some embodiments, a display order of the loaded sub-props in the sub-prop configuration display region is opposite to a loading order of the loaded sub-props. The method further includes: determining, in response to a firing (or discharge) operation on the target virtual prop, a target fire sub-prop corresponding to the firing operation based on the display order of the loaded sub-props, and controlling the target virtual prop to fire the target fire sub-prop in the virtual scene.

In some embodiments, after the displaying, in the sub-prop configuration display region, prop identifiers of the updated loaded sub-props according to a loading order of the updated loaded sub-props, the method further includes: displaying, in response to a hover operation on the sub-prop configuration display region, a quantity and type of the updated loaded sub-props.

In some embodiments, the graphical user interface further includes a sub-prop storage display region, and the sub-prop storage display region is used for displaying non-loaded sub-props in a prop storage equipment of the controlled virtual object. The method further includes: displaying an unloading control in response to a click operation on the sub-prop configuration display region; determining, in response to a selection operation on the unloading control, whether a remaining capacity of the prop storage equipment is greater than or equal to the quantity of loaded sub-props in the target virtual prop; determining the loaded sub-prop as an unloaded sub-prop if the remaining capacity is greater than the quantity of loaded sub-props; updating a display effect of the sub-prop configuration display region, where the updated display effect indicates that the loaded sub-prop in the target virtual prop is empty; and updating display of non-loaded bullets in the sub-prop storage display region, where the unloaded sub-prop is displayed in the sub-prop configuration display region after the display is updated.

In some embodiments, the method further includes: determining, if it is monitored that a trajectory of the drag operation is located in the sub-prop storage display region, whether the target non-loaded sub-prop matches the target virtual prop; controlling, if they match, the sub-prop configuration display region to be displayed in a first display format, where the first display format indicates that the sub-prop configuration display region is in an interactive state; controlling, if they do not match, the sub-prop configuration display region to be displayed in a second display format, where the second display format indicates that the sub-prop configuration display region is in a disabled state; controlling, if it is monitored that a trajectory of the drag operation is located in the sub-prop configuration display region, the sub-prop configuration display region to be displayed in a third display format, where the third display format indicates that the sub-prop configuration display region is in an interactive response state; and canceling, if an end event of the drag operation is monitored, the display of the sub-prop configuration display region in the third display format.

In some embodiments, the sub-props correspond to a plurality of prop types, the target virtual prop matches a sub-prop corresponding to a target prop type, and the target prop type includes one or more types. The step of determining whether the target non-loaded sub-prop matches the target virtual prop includes: determining whether a prop type corresponding to the target non-loaded sub-prop belongs to the target prop type corresponding to the target virtual prop; determining, if yes, that the target non-loaded sub-prop matches the target virtual prop; and determining, if no, that the target non-loaded sub-prop does not match the target virtual prop.

In some embodiments, the display information includes prop identifiers of a plurality of loaded sub-props. The method further includes: updating, in response to a drag operation on a prop identifier of a first sub-prop among the plurality of loaded sub-props, display of the prop identifiers of the loaded sub-props in the sub-prop configuration display region based on a display position of a second sub-prop corresponding to an end position of the drag operation, where the prop identifier of the first sub-prop among the updated prop identifiers is displayed at the end position of the drag operation.

In some embodiments, the sub-prop storage display region includes a first sub-region and at least one second sub-region, and the first sub-region displays non-loaded sub-props having a first quantity. The method further includes: displaying, in response to a split operation on the non-loaded sub-props in the first sub-region, a quantity input window corresponding to the non-loaded sub-props in the first sub-region; displaying, in response to an edit operation on the quantity input window, a quantity of sub-props corresponding to the edit operation, where the quantity input window includes a confirmation control; canceling, in response to a selection operation on the confirmation control, the display of the quantity input window; and controlling, based on the quantity of sub-props, update of the first quantity of non-loaded sub-props in the first sub-region, and displaying the non-loaded sub-props having the quantity of sub-props in the second sub-region.

In some embodiments, the step of displaying, in the sub-prop configuration display region, prop identifiers of the updated loaded sub-props according to a loading order of the updated loaded sub-props includes: dividing the loaded sub-props into at least one prop display group based on a preset display quantity and the loading order of the updated loaded sub-props, where the prop display group includes at least one loaded sub-prop, and the quantity of loaded sub-props in the prop display group is less than or equal to the display quantity; determining a target prop display group from the at least one prop display group based on the loading order of the loaded sub-props, and displaying the prop identifiers of the loaded sub-props in the target prop display group in the sub-prop configuration display region; and determining, in response to a hover operation on the sub-prop configuration display region, a next target prop display group of the target prop display group from the at least one prop display group, and displaying the prop identifiers of the loaded sub-props in the next target prop display group in the sub-prop configuration display region.

In some embodiments, the graphical user interface further includes a sub-prop storage display region, and the sub-prop storage display region displays the prop identifiers and quantity information of non-loaded sub-props in a prop storage equipment of the controlled virtual object. The step of determining, in response to a loading operation, a target sub-prop corresponding to the loading operation includes: displaying, in response to a selection operation on the prop identifier of the non-loaded sub-prop in the sub-prop storage display region, a target loading quantity input window corresponding to the non-loaded sub-prop; determining, in response to an edit operation on the target loading quantity input window, editing content corresponding to the edit operation as a target quantity of the target sub-props, and updating the quantity information of the non-loaded sub-props displayed in the sub-prop storage display region based on the editing content and the quantity information; and determining the non-loaded sub-prop of a quantity matching the target quantity as the target sub-prop.

Referring to FIG. 13, the electronic device includes a processor 100 and a memory 101, where machine-executable instructions executable by the processor 100 are stored in the memory 101, and the processor 100 executes the machine-executable instructions to implement the above interaction control method for a virtual prop.

Furthermore, the electronic device shown in FIG. 13 further includes a bus 102 and a communication interface 103, and the processor 100, the communication interface 103 and the memory 101 are connected via the bus 102.

The memory 101 may include a high-speed Random Access Memory (RAM), and may also include a non-volatile memory, such as at least one magnetic disk memory. The communication connection between a network element of the system and at least one other network element is realized through at least one communication interface 103 (which may be wired or wireless), and the Internet, wide area network, local area network, metropolitan area network, and the like may be used. The bus 102 may be an ISA bus, a PCI bus, an EISA bus, or the like. The bus may be classified into an address bus, a data bus, a control bus, and the like. For ease of representation, FIG. 13 only uses one bidirectional arrow, but this does not mean that there is only one bus or one type of bus.

The processor 100 may be an integrated circuit chip having a signal processing capability. During implementation, various steps of the above method may be completed by an integrated logic circuit of hardware in the processor 100 or by instructions in software form. The processor 100 may be a general-purpose processor, including a Central Processing Unit (CPU), a Network Processor (NP), and the like; it may also be a Digital Signal Processor (DSP), an Application Specific Integrated Circuit (ASIC), a Field-Programmable Gate Array (FPGA), or another programmable logic device, discrete gate or transistor logic device, and discrete hardware component. The various methods, steps, and logic block diagrams disclosed in the embodiments of the present disclosure may be implemented or performed. The general-purpose processor may be a microprocessor, or the processor may be any conventional processor or the like. The steps of the method disclosed in the embodiments of the present disclosure may be directly embodied as being executed by a hardware decoding processor, or as being executed by a combination of hardware and software modules in the decoding processor. The software module may be located in a random access memory, a flash memory, a read-only memory, a programmable read-only memory or an electrically erasable programmable memory, a register, or other mature storage media in the art. The storage medium is located in the memory 101, and the processor 100 reads information in the memory 101 and completes the steps of the method of the above embodiment in combination with its hardware.

This embodiment may further provide a machine-readable storage medium storing machine-executable instructions, where when the machine-executable instructions are called and executed by a processor, the machine-executable instructions prompt the processor to implement the above interaction control method for a virtual prop.

The method provides a graphical user interface by means of a terminal device, the graphical user interface displays a prop operation interface, the prop operation interface including a target virtual prop carried by a controlled virtual object, and a sub-prop configuration display region corresponding to the target virtual prop, where the sub-prop is configured as a prop which is fired in a virtual scene by the target virtual prop, and the sub-prop configuration display region is used for displaying a loaded sub-prop of the target virtual prop. A target sub-prop corresponding to a loading operation is determined in response to the loading operation, and the target sub-prop is controlled to be loaded to the target virtual prop. Display of display information in the sub-prop configuration display region is updated, where the updated display information includes information corresponding to the target sub-prop.

While ensuring the use feeling of a player on the target virtual prop, the method simplifies the sub-prop loading process, thereby improving the user experience.

In some embodiments, the above loading operation includes a trigger operation on a loading control. The step of determining, in response to a loading operation, a target sub-prop corresponding to the loading operation includes: displaying the loading control in response to a click operation on the sub-prop configuration display region; and determining, in response to the trigger operation on the loading control, a target sub-prop corresponding to the trigger operation.

In some embodiments, the graphical user interface further includes a sub-prop storage display region, and the sub-prop storage display region is used for displaying non-loaded sub-props in a prop storage equipment of the controlled virtual object. The step of determining, in response to the trigger operation on the loading control, a target sub-prop corresponding to the trigger operation includes: determining, in response to the trigger operation on the loading control, a quantity of the target sub-props based on a remaining capacity of the target virtual prop and a quantity of non-loaded sub-props; sorting the non-loaded sub-props from large to small according to penetration parameters of the non-loaded sub-props to obtain a sorting result; selecting the non-loaded sub-props in sequence according to the sorting result until the quantity of selected non-loaded sub-props is equal to the quantity of target bullets; and determining the selected non-loaded sub-props as the target sub-props.

In some embodiments, the graphical user interface further includes a sub-prop storage display region, and the sub-prop storage display region is used for displaying non-loaded sub-props in a prop storage equipment of the controlled virtual object. The step of determining, in response to a loading operation, a target sub-prop corresponding to the loading operation includes: determining, in response to a selection operation on a non-loaded sub-prop in the sub-prop storage display region, the non-loaded sub-prop corresponding to the selection operation as a target non-loaded sub-prop; and determining, in response to a drag operation on the target non-loaded sub-prop, the target sub-prop to be loaded to the target virtual prop based on a remaining capacity of the target virtual prop and a quantity of the target non-loaded sub-props, where an end position of the drag operation is located in the sub-prop configuration display region.

In some embodiments, the remaining capacity indicates a quantity of sub-props that are loadable to the target virtual prop. The step of determining the target sub-prop to be loaded to the target virtual prop based on a remaining capacity of the target virtual prop and a quantity of the target non-loaded sub-props includes: determining a smaller one of the quantity of sub-props that are loadable to the target virtual prop and the quantity of the target non-loaded sub-props as the quantity of target sub-props; selecting the target non-loaded sub-props in sequence according to an order in which the target non-loaded sub-props are selected until the quantity of selected target non-loaded sub-props is equal to the quantity of target bullets; and determining the selected target non-loaded sub-props as the target sub-props.

In some embodiments, the sub-props correspond to a plurality of types, a prop identifier of the sub-prop corresponds to the type of the sub-prop, and the display information includes the prop identifiers and quantity of the loaded sub-props. The step of updating display of display information in the sub-prop configuration display region includes: displaying, in the sub-prop configuration display region, prop identifiers of the updated loaded sub-props according to a loading order of the updated loaded sub-props, where the updated loaded sub-props include the target sub-prop.

In some embodiments, a display order of the loaded sub-props in the sub-prop configuration display region is opposite to a loading order of the loaded sub-props. The method further includes: determining, in response to a firing (or discharge) operation on the target virtual prop, a target fire sub-prop corresponding to the firing operation based on the display order of the loaded sub-props, and controlling the target virtual prop to fire the target fire sub-prop in the virtual scene.

In some embodiments, after the displaying, in the sub-prop configuration display region, prop identifiers of the updated loaded sub-props according to a loading order of the updated loaded sub-props, the method further includes: displaying, in response to a hover operation on the sub-prop configuration display region, a quantity and type of the updated loaded sub-props.

In some embodiments, the graphical user interface further includes a sub-prop storage display region, and the sub-prop storage display region is used for displaying non-loaded sub-props in a prop storage equipment of the controlled virtual object. The method further includes: displaying an unloading control in response to a click operation on the sub-prop configuration display region; determining, in response to a selection operation on the unloading control, whether a remaining capacity of the prop storage equipment is greater than or equal to the quantity of loaded sub-props in the target virtual prop; determining the loaded sub-prop as an unloaded sub-prop if the remaining capacity is greater than the quantity of loaded sub-props; updating a display effect of the sub-prop configuration display region, where the updated display effect indicates that the loaded sub-prop in the target virtual prop is empty; and updating display of non-loaded bullets in the sub-prop storage display region, where the unloaded sub-prop is displayed in the sub-prop configuration display region after the display is updated.

In some embodiments, the method further includes: determining, if it is monitored that a trajectory of the drag operation is located in the sub-prop storage display region, whether the target non-loaded sub-prop matches the target virtual prop; controlling, if they match, the sub-prop configuration display region to be displayed in a first display format, where the first display format indicates that the sub-prop configuration display region is in an interactive state; controlling, if they do not match, the sub-prop configuration display region to be displayed in a second display format, where the second display format indicates that the sub-prop configuration display region is in a disabled state; controlling, if it is monitored that a trajectory of the drag operation is located in the sub-prop configuration display region, the sub-prop configuration display region to be displayed in a third display format, where the third display format indicates that the sub-prop configuration display region is in an interactive response state; and canceling, if an end event of the drag operation is monitored, the display of the sub-prop configuration display region in the third display format.

In some embodiments, the sub-props correspond to a plurality of prop types, the target virtual prop matches a sub-prop corresponding to a target prop type, and the target prop type includes one or more types. The step of determining whether the target non-loaded sub-prop matches the target virtual prop includes: determining whether a prop type corresponding to the target non-loaded sub-prop belongs to the target prop type corresponding to the target virtual prop; determining, if yes, that the target non-loaded sub-prop matches the target virtual prop; and determining, if no, that the target non-loaded sub-prop does not match the target virtual prop.

In some embodiments, the display information includes prop identifiers of a plurality of loaded sub-props. The method further includes: updating, in response to a drag operation on a prop identifier of a first sub-prop among the plurality of loaded sub-props, display of the prop identifiers of the loaded sub-props in the sub-prop configuration display region based on a display position of a second sub-prop corresponding to an end position of the drag operation, where the prop identifier of the first sub-prop among the updated prop identifiers is displayed at the end position of the drag operation.

In some embodiments, the sub-prop storage display region includes a first sub-region and at least one second sub-region, and the first sub-region displays non-loaded sub-props having a first quantity. The method further includes: displaying, in response to a split operation on the non-loaded sub-props in the first sub-region, a quantity input window corresponding to the non-loaded sub-props in the first sub-region; displaying, in response to an edit operation on the quantity input window, a quantity of sub-props corresponding to the edit operation, where the quantity input window includes a confirmation control; canceling, in response to a selection operation on the confirmation control, the display of the quantity input window; and controlling, based on the quantity of sub-props, update of the first quantity of non-loaded sub-props in the first sub-region, and displaying the non-loaded sub-props having the quantity of sub-props in the second sub-region.

In some embodiments, the step of displaying, in the sub-prop configuration display region, prop identifiers of the updated loaded sub-props according to a loading order of the updated loaded sub-props includes: dividing the loaded sub-props into at least one prop display group based on a preset display quantity and the loading order of the updated loaded sub-props, where the prop display group includes at least one loaded sub-prop, and the quantity of loaded sub-props in the prop display group is less than or equal to the display quantity; determining a target prop display group from the at least one prop display group based on the loading order of the loaded sub-props, and displaying the prop identifiers of the loaded sub-props in the target prop display group in the sub-prop configuration display region; and determining, in response to a hover operation on the sub-prop configuration display region, a next target prop display group of the target prop display group from the at least one prop display group, and displaying the prop identifiers of the loaded sub-props in the next target prop display group in the sub-prop configuration display region.

In some embodiments, the graphical user interface further includes a sub-prop storage display region, and the sub-prop storage display region displays the prop identifiers and quantity information of non-loaded sub-props in a prop storage equipment of the controlled virtual object. The step of determining, in response to a loading operation, a target sub-prop corresponding to the loading operation includes: displaying, in response to a selection operation on the prop identifier of the non-loaded sub-prop in the sub-prop storage display region, a target loading quantity input window corresponding to the non-loaded sub-prop; determining, in response to an edit operation on the target loading quantity input window, editing content corresponding to the edit operation as a target quantity of the target sub-props, and updating the quantity information of the non-loaded sub-props displayed in the sub-prop storage display region based on the editing content and the quantity information; and determining the non-loaded sub-prop of a quantity matching the target quantity as the target sub-prop.

For the interaction control method and apparatus for a virtual prop and the electronic device provided in the embodiments of the present disclosure, a computer-readable storage medium storing program code is included. Instructions included in the program code may be used for performing the method in the previous method embodiment. The specific implementation may be obtained with reference to the method embodiment, which may not be repeated here.

Persons skilled in the art can clearly know that, for ease and clarity of descriptions, specific working processes of the system and apparatus described in the above may be obtained with reference to corresponding processes in the foregoing method embodiments, and are not repeated herein.

In addition, in the description of the embodiments of the present disclosure, unless otherwise clearly specified and limited, the terms “install”, “connected”, and “connect” should be understood in a broad sense. For example, it may be a fixed connection, a detachable connection, or an integral connection; it may be a mechanical connection or an electrical connection; it may be a direct connection or an indirect connection through an intermediate medium, and it may be the internal communication of two elements. For those skilled in the art, the specific meanings of the above terms in the present disclosure may be understood according to specific circumstances.

The functions, if implemented in the form of software functional units and sold or used as independent products, may be stored in a computer readable storage medium. Based on such an understanding, the technical solutions of the present disclosure essentially, or the part contributing to the prior art, or a part of the technical solution may be implemented in the form of a software product. The computer software product may be stored in a storage medium, and includes several instructions for instructing a computer device (which may be a personal computer, a server, a network device or the like) to perform all or a part of the steps in the methods described in the embodiments of the present disclosure. The storage medium includes: a USB flash disk, a mobile hard disk, a Read-Only Memory (ROM), a Random Access Memory (RAM), a magnetic disk, an optical disc, or other mediums that can store program codes.

In the descriptions of the present disclosure, it should be noted that orientation or position relationships indicated by terms such as “center”, “upper”, “lower”, “left”, “right”, “vertical”, “horizontal”, “inner”, and “out” are based on orientation or position relationships shown in the accompanying drawings, and are merely used to facilitate description of the present disclosure and simplified description, instead of indicating or implying that the specified apparatus or element must have the specific orientations or must be constructed and operated in specific orientations, and therefore, they cannot be considered as limitations on the present disclosure. Moreover, terms “first”, “second”, and “third” are merely used for the purpose of description, and cannot be understood as indicating or implying relative importance.

Finally, it should be noted that the above embodiments are only specific embodiments of the present disclosure, which are used to illustrate the technical solutions of the present disclosure rather than to limit them. The protection scope of the present disclosure is not limited thereto. Although the present disclosure has been described in detail with reference to the aforementioned embodiments, those skilled in the art should understand that any technician familiar with the technical field can still modify the technical solutions recorded in the aforementioned embodiments within the technical scope disclosed in the present disclosure or easily derive changes, or make equivalent replacements for some of the technical features therein. Such modifications, changes, or replacements do not deviate the essence of the corresponding technical solutions from the spirit and scope of the technical solutions of the embodiments of the present disclosure, and should all be covered by the protection scope of the present disclosure. Therefore, the protection scope of the present disclosure shall subject to the protection scope of the claims.

1. An interaction control method for a virtual prop, comprising:
displaying a prop operation interface by a graphical user interface, the prop operation interface comprising a target virtual prop carried by a controlled virtual object, and a sub-prop configuration display region for a sub-prop corresponding to the target virtual prop, wherein the sub-prop is configured as a prop discharged by the target virtual prop in a virtual scene, and the sub-prop configuration display region is configured for displaying a loaded sub-prop of the target virtual prop, and the graphical user interface is provided by a terminal device;
determining, in response to a loading operation, a target sub-prop corresponding to the loading operation, and controlling the target sub-prop to be loaded to the target virtual prop; and
updating display information in the sub-prop configuration display region, wherein the updated display information comprises information corresponding to the target sub-prop.

2. The method according to claim 1, wherein the loading operation comprises a trigger operation on a loading control, and determining, in response to the loading operation, the target sub-prop corresponding to the loading operation comprises:
displaying the loading control in response to a click operation on the sub-prop configuration display region; and
determining, in response to the trigger operation on the loading control, the target sub-prop corresponding to the trigger operation.

3. The method according to claim 2, wherein the graphical user interface comprises a sub-prop storage display region, and the sub-prop storage display region is configured for displaying non-loaded sub-props in a prop storage equipment of the controlled virtual object, and determining, in response to the trigger operation on the loading control, the target sub-prop corresponding to the trigger operation comprises:
determining, in response to the trigger operation on the loading control, a quantity of the target sub-props based on a remaining capacity of the target virtual prop and a quantity of the non-loaded sub-props;
sorting the non-loaded sub-props in a descending order according to penetration parameters of the non-loaded sub-props to obtain a sorting result;
selecting the non-loaded sub-props in sequence according to the sorting result until a quantity of selected non-loaded sub-props is equal to a quantity of target bullets; and
determining the selected non-loaded sub-props as the target sub-props.

4. The method according to claim 1, wherein the graphical user interface further comprises a sub-prop storage display region, and the sub-prop storage display region is configured for displaying non-loaded sub-props in a prop storage equipment of the controlled virtual object, and the step of determining, in response to the loading operation, the target sub-prop corresponding to the loading operation comprises:
determining, in response to a selection operation on a non-loaded sub-prop in the sub-prop storage display region, the non-loaded sub-prop corresponding to the selection operation as a target non-loaded sub-prop; and
determining, in response to a drag operation on the target non-loaded sub-prop, the target sub-prop to be loaded to the target virtual prop based on a remaining capacity of the target virtual prop and a quantity of the target non-loaded sub-props, wherein an end position of the drag operation is located in the sub-prop configuration display region.

5. The method according to claim 4, wherein the remaining capacity indicates a quantity of sub-props that are loadable to the target virtual prop, and determining the target sub-prop to be loaded to the target virtual prop based on the remaining capacity of the target virtual prop and the quantity of the target non-loaded sub-props comprises:
determining a smaller one of the quantity of sub-props that are loadable to the target virtual prop and the quantity of the target non-loaded sub-props as the quantity of target sub-props;
selecting the target non-loaded sub-props in sequence according to a selection order until a quantity of selected target non-loaded sub-props is equal to a quantity of target bullets; and
determining the selected target non-loaded sub-props as the target sub-props.

6. The method according to claim 1, wherein the sub-props correspond to a plurality of types, a prop identifier of the sub-prop corresponds to a type of the sub-prop, and the display information comprises the prop identifiers and a quantity of the loaded sub-props, and updating the display information in the sub-prop configuration display region comprises:
displaying, in the sub-prop configuration display region, prop identifiers of updated loaded sub-props according to a loading order of the updated loaded sub-props, wherein the updated loaded sub-props comprise the target sub-prop.

7. The method according to claim 6, wherein a display order of the updated loaded sub-props in the sub-prop configuration display region is opposite to the loading order of the updated loaded sub-props, and the method further comprises:
determining, in response to a discharge operation on the target virtual prop, a target discharge sub-prop corresponding to the discharge operation based on the display order of the updated loaded sub-props; and
controlling the target virtual prop to fire discharge the target discharge sub-prop in the virtual scene.

8. The method according to claim 6, wherein after the displaying, in the sub-prop configuration display region, the prop identifiers of the updated loaded sub-props according to the loading order of the updated loaded sub-props, the method further comprises:
displaying, in response to a hover operation on the sub-prop configuration display region, a quantity of the updated loaded sub-props and a type of each of the updated loaded sub-props.

9. The method according to claim 1, wherein the graphical user interface comprises a sub-prop storage display region, and the sub-prop storage display region is configured for displaying non-loaded sub-props in a prop storage equipment of the controlled virtual object, and the method further comprises:
displaying an unloading control in response to a click operation on the sub-prop configuration display region;
determining, in response to a selection operation on the unloading control, whether a remaining capacity of the prop storage equipment is greater than or equal to a quantity of loaded sub-props in the target virtual prop;
determining, in response to the remaining capacity is greater than the quantity of loaded sub-props, the loaded sub-prop as an unloaded sub-prop;
updating a display effect of the sub-prop configuration display region, wherein the updated display effect indicates that the loaded sub-prop in the target virtual prop is empty; and
updating a display of non-loaded bullets in the sub-prop storage display region, wherein the unloaded sub-prop is displayed in the sub-prop configuration display region after the display is updated.

10. The method according to claim 4, wherein the method further comprises:
determining, in response to monitoring that a trajectory of the drag operation is located in the sub-prop storage display region, whether the target non-loaded sub-prop matches the target virtual prop;
controlling, in response to the target non-loaded sub-prop matches the target virtual prop, the sub-prop configuration display region to be displayed in a first display format, wherein the first display format indicates that the sub-prop configuration display region is in an interactive state;
controlling, in response to the target non-loaded sub-prop does not match the target virtual prop, the sub-prop configuration display region to be displayed in a second display format, wherein the second display format indicates that the sub-prop configuration display region is in a disabled state;
controlling, in response to monitoring that a trajectory of the drag operation is located in the sub-prop configuration display region, the sub-prop configuration display region to be displayed in a third display format, wherein the third display format indicates that the sub-prop configuration display region is in an interactive response state; and
canceling, in response to an end event of the drag operation is monitored, the sub-prop configuration display region in the third display format.

11. The method according to claim 10, wherein the sub-props correspond to a plurality of prop types, the target virtual prop matches a sub-prop corresponding to a target prop type the target prop type comprises one or more prop types, and determining whether the target non-loaded sub-prop matches the target virtual prop comprises:
determining whether a prop type corresponding to the target non-loaded sub-prop belongs to the target prop type corresponding to the target virtual prop;
determining, in response to the prop type corresponding to the target non-loaded sub-prop belongs to the target prop type corresponding to the target virtual prop, that the target non-loaded sub-prop matches the target virtual prop; and
determining, in response to the prop type corresponding to the target non-loaded sub-prop does not belong to the target prop type corresponding to the target virtual prop, that the target non-loaded sub-prop does not match the target virtual prop.

12. The method according to claim 1, wherein the display information comprises prop identifiers of a plurality of loaded sub-props, and the method further comprises:
updating, in response to a drag operation on a prop identifier of a first sub-prop among the plurality of loaded sub-props, the prop identifiers of the loaded sub-props in the sub-prop configuration display region based on a display position of a second sub-prop corresponding to an end position of the drag operation, wherein the prop identifier of the first sub-prop among the updated prop identifiers is displayed at the end position of the drag operation.

13. The method according to claim 4, wherein the sub-prop storage display region comprises a first sub-region and a second sub-region, the first sub-region displays non-loaded sub-props having a first quantity, and the method further comprises:
displaying, in response to a split operation on the non-loaded sub-props in the first sub-region, a quantity input window corresponding to the non-loaded sub-props in the first sub-region;
displaying, in response to an edit operation on the quantity input window, a quantity of sub-props corresponding to the edit operation, wherein the quantity input window comprises a confirmation control;
canceling, in response to a selection operation on the confirmation control, the quantity input window;
updating, based on the quantity of sub-props, the first quantity of non-loaded sub-props in the first sub-region; and
displaying the non-loaded sub-props having the quantity of sub-props corresponding to the edit operation in the second sub-region.

14. The method according to claim, wherein displaying, in the sub-prop configuration display region, the prop identifiers of the updated loaded sub-props according to the loading order of the updated loaded sub-props comprises:
dividing the updated loaded sub-props into one or more prop display groups based on a preset display quantity and the loading order of the updated loaded sub-props, wherein a prop display group comprises one or more updated loaded sub-props, and a quantity of the one or more updated loaded sub-props in the prop display group is less than or equal to the preset display quantity;
determining a target prop display group from the one or more prop display groups based on the loading order of the updated loaded sub-props;
displaying the prop identifiers of the updated loaded sub-props in the target prop display group in the sub-prop configuration display region; and
determining, in response to a hover operation on the sub-prop configuration display region, a next target prop display group from the one or more prop display groups; and
displaying the prop identifiers of the updated loaded sub-props in the next target prop display group in the sub-prop configuration display region.

15. The method according to claim 1, wherein the graphical user interface comprises a sub-prop storage display region, and the sub-prop storage display region displays prop identifiers and quantity information of non-loaded sub-props in a prop storage equipment of the controlled virtual object, and the step of determining, in response to the loading operation, the target sub-prop corresponding to the loading operation comprises:
displaying, in response to a selection operation on the prop identifier of the non-loaded sub-prop in the sub-prop storage display region, a target loading quantity input window corresponding to the non-loaded sub-prop;
determining, in response to an edit operation on the target loading quantity input window, editing content corresponding to the edit operation as a target quantity of the target sub-props; and
updating the quantity information of the non-loaded sub-props displayed in the sub-prop storage display region based on the editing content and the quantity information; and
determining the non-loaded sub-prop having a quantity matching the target quantity as the target sub-prop.

16. (canceled)

17. A system, comprising:
one or more memories collectively containing one or more programs; and
one or more processors, wherein the one or more processors are configured to, individually or collectively, perform an operation comprising:
displaying a prop operation interface by a graphical user interface, the prop operation interface comprising a target virtual prop carried by a controlled virtual object, and a sub-prop configuration display region for a sub-prop corresponding to the target virtual prop, wherein the sub-prop is configured as a prop discharged by the target virtual prop in a virtual scene, the sub-prop configuration display region is configured for displaying a loaded sub-prop of the target virtual prop, and the graphical user interface is provided by a terminal device;
determining, in response to a loading operation, a target sub-prop corresponding to the loading operation, and controlling the target sub-prop to be loaded to the target virtual prop; and
updating display information in the sub-prop configuration display region, wherein the updated display information comprises information corresponding to the target sub-prop.

18. One or more non-transitory computer-readable storage media containing, in any combination, computer program code that, when executable by a computer system, perform an operation comprising:
displaying a prop operation interface by a graphical user interface, the prop operation interface comprising a target virtual prop carried by a controlled virtual object, and a sub-prop configuration display region for a sub-prop corresponding to the target virtual prop, wherein the sub-prop is configured as a prop discharged by the target virtual prop in a virtual scene, the sub-prop configuration display region is configured for displaying a loaded sub-prop of the target virtual prop, and the graphical user interface is provided by a terminal device;
determining, in response to a loading operation, a target sub-prop corresponding to the loading operation, and controlling the target sub-prop to be loaded to the target virtual prop; and
updating display information in the sub-prop configuration display region, wherein the updated display information comprises information corresponding to the target sub-prop.

19. The system according to claim 17, wherein the loading operation comprises a trigger operation on a loading control, and determining, in response to the loading operation, the target sub-prop corresponding to the loading operation comprises:
displaying the loading control in response to a click operation on the sub-prop configuration display region; and
determining, in response to the trigger operation on the loading control, the target sub-prop corresponding to the trigger operation.

20. The system according to claim 17, wherein the graphical user interface comprises a sub-prop storage display region, and the sub-prop storage display region is configured for displaying non-loaded sub-props in a prop storage equipment of the controlled virtual object, and determining, in response to the loading operation, the target sub-prop corresponding to the loading operation comprises:
determining, in response to a selection operation on a non-loaded sub-prop in the sub-prop storage display region, the non-loaded sub-prop corresponding to the selection operation as a target non-loaded sub-prop; and
determining, in response to a drag operation on the target non-loaded sub-prop, the target sub-prop to be loaded to the target virtual prop based on a remaining capacity of the target virtual prop and a quantity of the target non-loaded sub-props, wherein an end position of the drag operation is located in the sub-prop configuration display region.

21. The system according to claim 17, wherein the graphical user interface comprises a sub-prop storage display region, and the sub-prop storage display region is configured for displaying non-loaded sub-props in a prop storage equipment of the controlled virtual object, and the operation further comprises:
displaying an unloading control in response to a click operation on the sub-prop configuration display region;
determining, in response to a selection operation on the unloading control, whether a remaining capacity of the prop storage equipment is greater than or equal to a quantity of loaded sub-props in the target virtual prop;
determining, in response to the remaining capacity is greater than the quantity of loaded sub-props, the loaded sub-prop as an unloaded sub-prop;
updating a display effect of the sub-prop configuration display region, wherein the updated display effect indicates that the loaded sub-prop in the target virtual prop is empty; and
updating a display of non-loaded bullets in the sub-prop storage display region, wherein the unloaded sub-prop is displayed in the sub-prop configuration display region after the display is updated.
